(19) United States
(12) Patent Application Publication
(10) Pub. No.: US 2016/0094443 A1
(43) Pub. Date: Mar. 31, 2016

(54) PROTOCOL INDEPENDENT MULTICAST (PIM) MULTICAST ROUTE ENTRY SYNCHRONIZATION

(71) Applicant: LENOVO Enterprise Solutions (Singapore) PTE, LTD., New Tech Park (SG)

(72) Inventors: Sivakumar Arumugam, Milpitas, CA (US); Chidambaram Bhagavathiperumal, Santa Clara, CA (US); Solomon Coriiu, Bucharest (RO); Angu S. Chandra Sekaran, Santa Clara, CA (US); Ashok K.M. Somosundaram, Santa Clara, CA (US)

(21) Appl. No.: 14/498,041

(22) Filed: Sep. 26, 2014

(51) Int. Cl. H04L 12/721; H04L 12/743; H04L 12/931

(52) U.S. Cl. CPC H04L 45/72; H04L 49/201; H04L 49/70; H04L 45/7453

(57) ABSTRACT

Embodiments of the invention relate to synchronizing multicast route entries in a system. One embodiment includes forwarding a communication packet to a first switch and determining a multicast source route entry by the first switch based on the communication packet. The communication packet is forwarded from the first switch to a second switch. The multicast source route entry is determined by the second switch based on the forwarded communication packet.

### BACKGROUND

The present invention relates to network switches and switching, and more particularly, this invention relates to protocol independent multicast (PIM) multicast route entry synchronization in a virtual link aggregation group (vLAG) topology.

In a data center comprising one or more access switches, each access switch connects two aggregation switches for redundancy. Link aggregation uses available bandwidth across a switch boundary at an aggregation layer.

### BRIEF SUMMARY

Embodiments of the invention relate to protocol independent multicast (PIM) synchronization of multicast route entries in a virtual link aggregation group (vLAG) topology. One embodiment includes forwarding a communication packet to a first switch and determining a multicast source route entry by the first switch based on the communication packet. The communication packet is forwarded from the first switch to a second switch. The multicast source route entry is determined by the second switch based on the forwarded communication packet.

Another embodiment comprises a system including an access switch that receives a communication packet from a multicast source. A first vLAG switch receives the communication packet from the access switch and extracts a multicast source route entry from the received communication packet. A second vLAG switch receives the communication packet from the first vLAG switch and extracts the multicast source route entry from the received communication packet.

One embodiment comprises a computer program product for synchronization of multicast source route entries over a link aggregation group (LAG). The computer program product comprising a computer readable storage medium having program instructions embodied therewith. The computer readable storage medium is not a transitory signal per se. The program instructions executable by an access switch to cause the access switch to perform a method comprising: forwarding, by the access switch, a communication packet to a first virtual link aggregation group (vLAG) switch. The first vLAG switch determines a multicast source route entry based on the communication packet. The first vLAG switch forwards the communication packet to a second vLAG switch. The second vLAG switch determines the multicast source route entry based on the forwarded communication packet.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a network architecture, in accordance with one embodiment of the invention;

FIG. 2 shows a representative hardware environment that may be associated with the servers and/or clients of FIG. 1, in accordance with one embodiment of the invention;

FIG. 3 is a diagram of an example data center system, in which an embodiment of the invention may be implemented;

FIG. 4 is a flow diagram of a synchronization process, according to one embodiment of the invention; and

FIG. 5 is a block diagram showing another process, in accordance with an embodiment of the invention.

### DETAILED DESCRIPTION

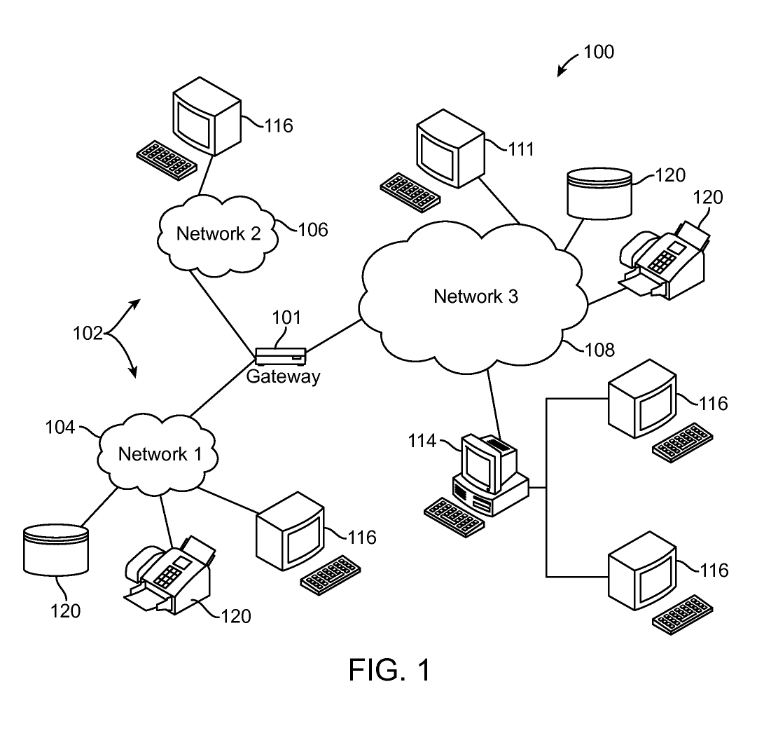

Referring now to the drawings, FIG. 1 illustrates a network architecture 100, in accordance with one embodiment. As shown in FIG. 1, a plurality of remote networks 102 are provided, including a first remote network 104 and a second remote network 106. A gateway 101 may be coupled between the remote networks 102 and a proximate network 108. In the context of the present network architecture 100, the networks 104, 106 may each take any form including, but not limited to, a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, handheld computer, printer, and/or any other type of logic-containing device. It should be noted that a user device 111 may also be directly coupled to any of the networks, in some embodiments.

A peripheral 120 or series of peripherals 120, e.g., facsimile machines, printers, scanners, hard disk drives, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods, and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In other examples, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, therefore allowing access and distribution of services across many computing systems. Cloud computing typically involves an Internet connection between the systems operating in the cloud, but other techniques of connecting the systems may also be used, as known in the art.

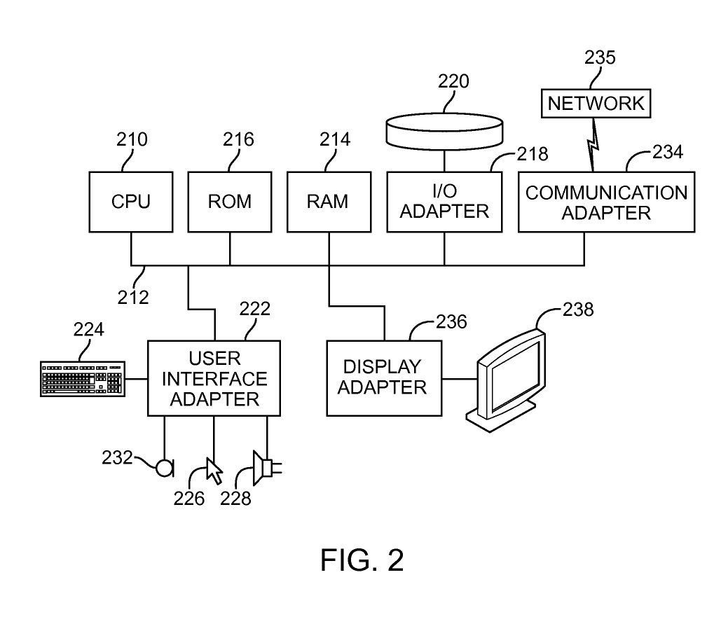

FIG. 2 shows a representative hardware environment associated with a user device 116 and/or server 114 of FIG. 1, in accordance with one embodiment. In one example, a hardware configuration includes a workstation having a central processing unit 210, such as a microprocessor, and a number of other units interconnected via a system bus 212. The workstation shown in FIG. 2 may include a Random Access Memory (RAM) 214, Read-Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen, a digital camera (not shown), etc., to the bus 212, communication adapter 234 for connecting the workstation to a communication network 235 (e.g., a data processing network), and a display adapter 236 for connecting the bus 212 to a display device 238.

In one example, the workstation may have resident thereon an operating system such as the MICROSOFT WINDOWS Operating System (OS), a MAC OS, a UNIX OS, etc. It will be appreciated that other examples may also be implemented on platforms and operating systems other than those mentioned. Such other examples may include operating systems written using JAVA, XML, C, and/or C++ language, or other programming languages, along with an object oriented programming methodology. Object oriented programming (OOP), which has become increasingly used to develop complex applications, may also be used.

According to an embodiment of the invention, protocol independent multicast (PIM) synchronization of multicast route entries in a virtual link aggregation group (vLAG) topology is provided. One embodiment includes forwarding a communication packet to a first switch and determining a multicast source route entry by the first switch based on the communication packet. The communication packet is forwarded from the first switch to a second switch. The multicast source route entry is determined by the second switch based on the forwarded communication packet.

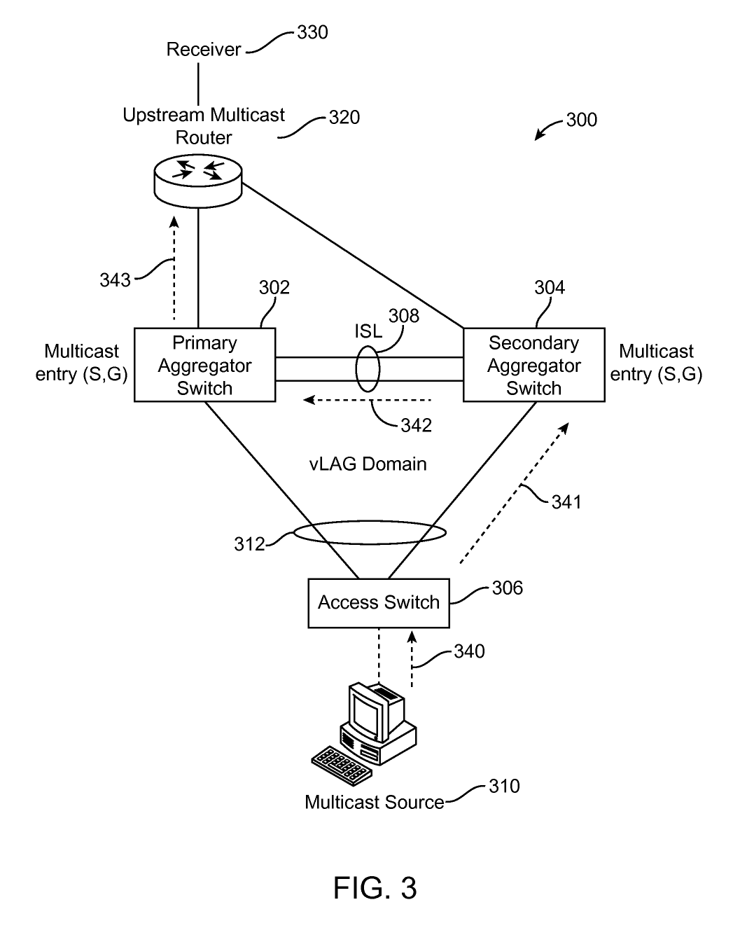

FIG. 3 is a diagram of an example data center system 300, in which an embodiment of the invention may be implemented. Each access switch 306 is connected to two aggregation switches for redundancy, for example, primary switch 302 and secondary switch 304. It should be noted that either switch 302 and 304 may be designated as the primary or secondary switch. VLAG is a feature that uses all available bandwidth without sacrificing redundancy and connectivity. Link aggregation is extended by vLAG across the switch boundary at the aggregation layer. Therefore, an access switch 306 has all uplinks in a LAG 312, while the aggregation switches 302, 304 cooperate with each other to maintain this vLAG.

Since vLAG is an extension to standard link aggregation, layer 2 and layer 3 features may be supported on top of vLAG. In the system 300 shown in FIG. 3, both primary aggregator switch 302 and secondary aggregator switch 304 have PIM enabled. PIM uses a routing table to discover whether a multicast packet has arrived on the correct interface. In conventional methods, synchronization of multicast group entries are achieved via special synchronization packets sent between the peer devices (primary switch 302 and secondary switch 304) using an inter-switch link (ISL) 308, which adds a latency to the traffic flow through the system 300. The multicast source entries include (S, G) information, where S represents an Internet Protocol (IP) address of a source device, and G represents a group address.

In one embodiment, the multicast source route entries (S, G) synchronization between the vLAG switches (primary aggregator switch 302 and secondary aggregator switch 304) occurs regardless whether designated router (DR) or non-designated router (Non-DR) processing occurs. In one example embodiment, when one of the vLAG switches receives the multicast traffic based on LAG hashing, that vLAG switch (primary aggregator switch 302 or secondary aggregator switch 304) will determine/learn the multicast source entries (S,G) and forwards the multicast traffic on the ISL 308 on the same vLAG. When the peer vLAG switch receives the multicast traffic on the ISL 308, that vLAG switch will also determine/learn the multicast source entries (S, G) with the same incoming interface as of the other vLAG switch. Thus the multicast source entries (S, G) are synchronized across both vLAG switches (primary aggregator switch 302 and secondary aggregator switch 304). In one embodiment, when one of the vLAG switches (primary aggregator switch 302 and secondary aggregator switch 304) or the link is interrupted/fails, the peer vLAG switch will take over traffic forwarding to the receiver 330 immediately; and when multicast traffic is received on the access switch 306 it will forward the traffic to one of the vLAG switches based on LAG hashing. On reception of the multicast traffic, the vLAG switches (primary aggregator switch 302 and secondary aggregator switch 304) determine/learn the multicast source entries (S, G) from the communication packet and forwards the multicast traffic on the ISL 308 on the same vLAG.

In one embodiment, the multicast traffic will always go through ISL 308 for entry refresh, until the traffic is stopped from the source 310. During vLAG device or link failover, the peer vLAG device will take care of traffic forwarding to the receiver 330 immediately. Advantages of this approach may include: no special synchronization mechanism is required; and no special processing is required for the multicast data traffic at the vLAG peer interface.

In one example, in the datacenter 300, both the primary vLAG switch (primary aggregator switch 302) and the secondary vLAG switch (secondary aggregator switch 304) have PIM enabled. When the multicast source 310 connected to the access switch 306 sends multicast traffic 340, the communication packet will be forwarded to only one of the vLAG switches (either primary or secondary) based on LAG hashing. In this example, the traffic 341 is forwarded to the secondary vLAG switch (secondary aggregator switch 304), which determines/learns the multicast source entry (S, G) based on the incoming multicast traffic 341. This multicast source route entry needs to be synchronized with the primary vLAG switch (primary aggregator switch 302) for traffic forwarding and redundancy. This is achieved by the secondary vLAG switch forwarding the multicast traffic 342 on the ISL 308 on the same vLAG. When the primary vLAG switch (primary aggregator switch 302) receives the multicast traffic 342 on the ISL 308, the primary vLAG switch will also determine/learn the multicast source entry (S, G) with the same incoming interface as the secondary vLAG switch. The primary vLAG switch will then forward the traffic 343 to the upstream multicast router 320 for forwarding to at a receiver 330. In one embodiment, the process of synchronizing the multicast source route entries (S, G) works similarly regardless of which vLAG switch (primary aggregator switch 302 or secondary aggregator switch 304) is targeted for forwarding traffic based on the LAG hashing.

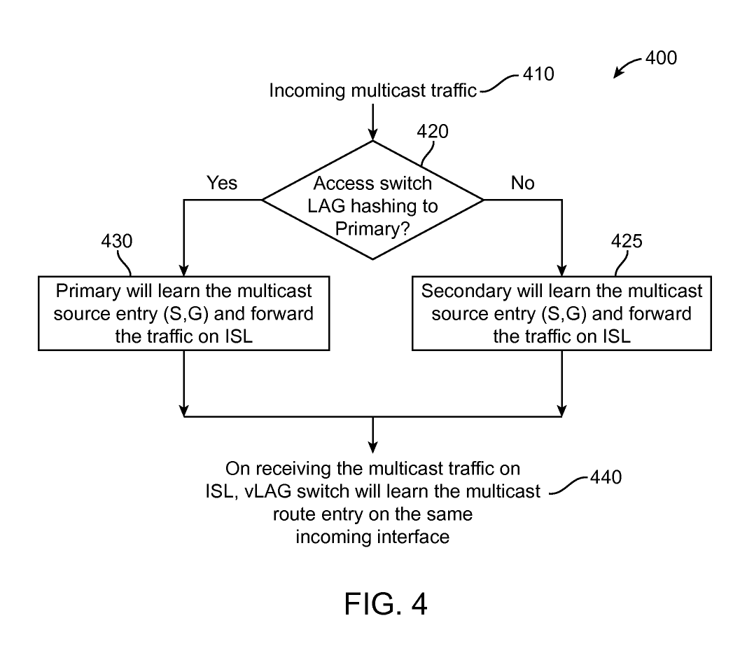

FIG. 4 shows a process 400 for synchronizing the multicast source route entry (S, G), according to one embodiment. In one embodiment, traffic is forwarded as incoming multicast traffic 410 from the multicast source 310 (FIG. 3). In block 430, the access switch then performs LAG hashing and determines whether to forward the multicast traffic 410 to the primary vLAG switch or the secondary vLAG switch. In one embodiment, if the LAG hashing forwards the traffic to the primary vLAG switch in block 430, the primary vLAG switch determines/learns the multicast route entries (S, G) and forwards the traffic on the ISL 308 (FIG. 3). If the LAG hashing forwards the traffic to the secondary vLAG switch in block 425, the secondary vLAG switch determines/learns the multicast source route entries (S, G) and forwards the traffic on the ISL 308. In block 440, on receiving the multicast traffic on the ISL 308, the vLAG switch will determine/learn the multicast route entries (S, G) on the same interface.

In one example embodiment, a PIM module may be disposed: within the access switch 306, external to and coupled with the access switch 306, etc. for processing and forwarding the multicast traffic to the primary/secondary vLAG switch over the ISL 308 for determining/learning the multicast route entries (S, G). In one embodiment, the PIM module or the access switch 306 may periodically check the status of multicast source route entry information for the first switch and the second switch to ensure the multicast source route entry information is synchronized on both of the first switch and the second switch.

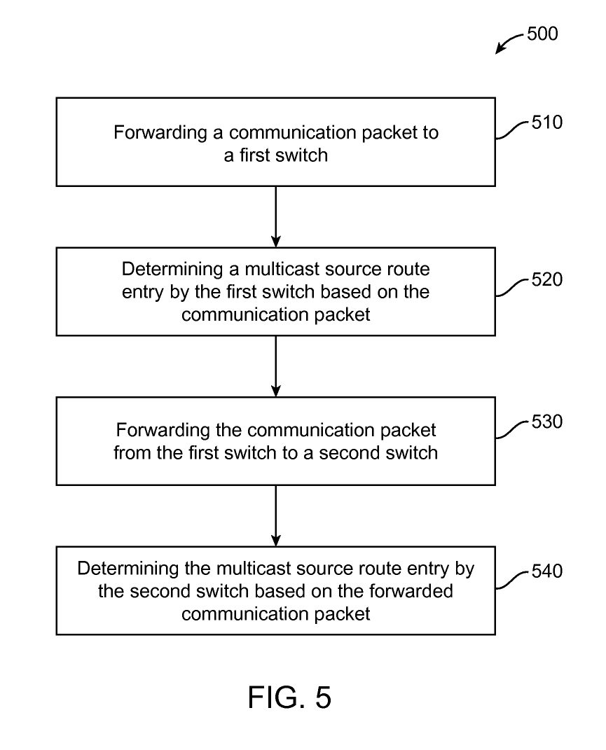

FIG. 5 shows a block diagram of a process 500 for vLAG entry synchronization, according to one embodiment. Process 500 may be performed in accordance with any of the environments depicted in FIGS. 1-3 among others, in various embodiments. Each of the blocks 510-540 of process 500 may be performed by any suitable component of the operating environment. In one example, process 500 may be partially or entirely performed by an aggregator switch, an access switch, a PIM module, etc.

As shown in FIG. 5, in process block 510, a communication packet (e.g., traffic including a multicast communication packet) is forwarded to a first switch (e.g., a primary or secondary vLAG switch). In block 520, a multicast source route/source entry is determined or learned by the first switch based on the forwarded communication packet. In one embodiment, in block 530, the communication packet is forwarded from the first switch to a second switch (e.g., over the ISL 308, FIG. 3). In block 540, the multicast source route entry is determined or learned by the second switch based on the forwarded communication packet. In one example, PIM is enabled on both the first and second switch in process 500.

In one embodiment, in process 500, the first switch and the second switch are part of a vLAG topology, and the communication packet is forwarded to the first switch based on LAG hashing. In one embodiment, in process 500, the second switch forwards the communication packet to a multicast router (e.g., multicast router 320, FIG. 3) for forwarding to a receiver (e.g., receiver 330). In one embodiment, process 500 may provide for multicast source route entry synchronization to the first switch and the second switch for traffic forwarding and redundancy regardless of DR or non-DR processing for the first switch and the second switch.

In one embodiment, for process 500 the first switch or the second switch is a primary vLAG switch, and the remaining switch is the secondary vLAG switch. In one embodiment, process 500 may provide for periodically checking the status of multicast source route entry information for the first switch and the second switch to ensure the multicast source route entry information is synchronized on both of the first switch and the second switch.

According to various embodiments, the process 500 may be performed by a system, computer, or some other device capable of executing commands, logic, etc., as would be understood by one of skill in the art upon reading the present descriptions.

According to the embodiments and approaches described herein, there is no need for an inter-switch synchronization mechanism for IP multicast group entries. Additionally, there is no special processing required for these packets at the peer node or switch (other than recognizing that the packet is received on a vLAG port and processing the packet accordingly).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
forwarding a communication packet to a first switch;
determining a multicast source route entry by the first switch based on the communication packet;
forwarding the communication packet from the first switch to a second switch; and
determining the multicast source route entry by the second switch based on the forwarded communication packet.

2. The method of claim 1, further comprising enabling protocol independent multicast (PIM) on the first switch and the second switch.

3. The method of claim 2, wherein the first switch and the second switch are part of a virtual link aggregation group (vLAG) topology, wherein the communication packet is forwarded to the first switch based on link aggregation group (LAG) hashing.

4. The method of claim 3, wherein the first switch forwards the communication packet over an inter-switch link (ISL).

5. The method of claim 4, further comprising the second switch forwarding the communication packet to a multicast router for forwarding to a receiver.

6. The method of claim 5, wherein multicast source route entry synchronization is provided to the first switch and the second switch for traffic forwarding and redundancy regardless of designated router (DR) or non-DR processing for the first switch and the second switch.

7. The method of claim 3, wherein one of the first switch and the second switch is a primary vLAG switch.

8. The method of claim 7, further comprising periodically checking the status of multicast source route entry information for the first switch and the second switch to ensure the multicast source route entry information is synchronized on both of the first switch and the second switch, wherein the multicast source route entry information comprises (S, G) information, where S represents an Internet Protocol (IP) address of a source device, and G represents a group address.

9. A system, comprising:
an access switch that receives a communication packet from a multicast source;
a first virtual link aggregation group (vLAG) switch that receives the communication packet from the access switch and that extracts a multicast source route entry from the received communication packet; and
a second vLAG switch that receives the communication packet from the first vLAG switch and that extracts the multicast source route entry from the received communication packet.

10. The system of claim 9, wherein protocol independent multicast (PIM) is enabled on the first vLAG switch and the second vLAG switch, wherein the communication packet is forwarded to the first vLAG switch based on LAG hashing.

11. The system of claim 10, wherein the first vLAG switch forwards the communication packet over an inter-switch link (ISL) to the second vLAG switch.

12. The system of claim 11, wherein the second vLAG switch forwards the communication packet to a multicast router for forwarding to a receiver.

13. The system of claim 12, wherein multicast source route entry synchronization occurs between the first vLAG switch and the second vLAG switch for traffic forwarding and redundancy regardless of designated router (DR) or non-DR processing for the first vLAG switch and the second vLAG switch.

14. The system of claim 11, wherein one of the first vLAG switch and the second vLAG switch is designated as a primary vLAG switch, and the multicast source route entry information comprises (S, G) information, where S represents an Internet Protocol (IP) address of a source device, and G represents a group address.

15. A computer program product for synchronization of multicast source route entries over a link aggregation group (LAG), the computer program product comprising a computer readable storage medium having program instructions embodied therewith, wherein the computer readable storage medium is not a transitory signal per se, the program instructions executable by an access switch to cause the access switch to perform a method comprising:
forwarding, by the access switch, a communication packet to a first virtual link aggregation group (vLAG) switch;
determining, by the first vLAG switch, a multicast source route entry based on the communication packet;
forwarding, by the first vLAG switch, the communication packet to a second vLAG switch; and
determining, by the second vLAG switch, the multicast source route entry based on the forwarded communication packet.

16. The computer program product of claim 15, wherein the method further comprises enabling protocol independent multicast (PIM) on the first switch and the second switch, wherein the first vLAG switch forwards the communication packet over an inter-switch link (ISL) to the second vLAG switch.

17. The computer program product of claim 16, wherein the method further comprises forwarding, by the second vLAG switch, the communication packet to a multicast router for forwarding to a receiver.

18. The computer program product of claim 16, wherein multicast source route entry synchronization is provided to the first vLAG switch and the second vLAG switch for traffic forwarding and redundancy regardless of designated router (DR) or non-DR processing for the first vLAG switch and the second vLAG switch.

19. The computer program product of claim 16, wherein the communication packet is forwarded to the first vLAG switch from the access switch based on LAG hashing, and one of the first vLAG switch and the second vLAG switch is a primary vLAG switch.

20. The computer program product of claim 19, wherein the method further comprises periodically checking, by the access switch, the status of multicast source route entry information for the first vLAG switch and the second vLAG switch to ensure the multicast source route entry information is synchronized on both of the first vLAG switch and the second vLAG switch, wherein the multicast source route entry information comprises (S, G) information, where S represents an Internet Protocol (IP) address of a source device, and G represents a group address.
